(19) United States
(12) Patent Application Publication
(10) Pub. No.: US 2011/0285651 A1
(43) Pub. Date: Nov. 24, 2011

(54) Multidirectional button, key, and keyboard

(76) Inventor: Will John Temple, Incline Village, NV (US)

(21) Appl. No.: 13/068,817

(22) Filed: May 19, 2011

Related U.S. Application Data
(60) Provisional application No. 61/396,261, filed on May 24, 2010.

(51) Int. Cl. G06F 3/041

(52) U.S. Cl. 345/173

(57) ABSTRACT

A multidirectional button for use in a user interface of a computing device (10). An object of the user interface may include a multidirectional button software keyboard (14) on a display screen (16).

### CROSS REFERENCE TO RELATED APPLICATION

This application claims the benefit of PPA Ser. No. 61/396,261, filed 2010 May 24 by the present inventor, which is incorporated by reference.

### BACKGROUND

1. Field of Invention

The disclosed embodiments and methods relate generally to user interfaces of computing devices and mobile electronic devices, and more particularly, to computing devices and mobile electronic devices that interpret user presses, releases, and motions of buttons, keys, or touch screen objects to determine device commands.

2. Description of Prior Art

Users of computing devices control the devices through a user interface. User interfaces have evolved from text based interfaces to graphical user interfaces, often referred to as GUI (Graphical User Interface). Graphical user interfaces generally use a pointer, controlled by a mouse, to select menus or buttons to input commands to the device. Menus act like a list of buttons and selecting a menu item requires placing the pointer over the menu item and then clicking on the menu item. Clicking on a menu item generally consists of pressing a mouse button and then, releasing the button. Menus are generally invoked by one of two methods. The first method is to move the pointer over a top menu item and click, whereby a submenu appears. The second method is to pop up a menu by clicking a mouse button, usually the right button. Menus are somewhat inefficient in that the pointer is usually at the top of the menu which usually consists of a vertical list of menu items. The user has to move the pointer half the distance of the list, on average, to choose a menu item. This is a farther distance than if the pointer were centered in the list. Both top level menus and buttons take up display screen real estate reducing the amount of program content that can be displayed. Menus are almost impossible to use without the user visually keeping track of the position of the pointer, and which menu item the pointer is over.

As portable computing devices become smaller, the size of their display screens and the objects available for physical user input have become smaller. A small display screen, one that is much smaller than a desktop or laptop computer's display screen, presents a significant challenge to provide a user interface that allows users to easily interact with a computing device with a minimum of misinterpreted commands and gestures.

On many portable computing devices, touch screen user interfaces have replaced mouse and pointer user interfaces. The user touches the screen with a finger, or stylus to enter commands into a device. The user may touch an on-screen button to invoke a command. Touch user interfaces generally dispense with menus, as they take up to much screen space, in favor of on-screen touch buttons. Buttons, however, are limited to one command and, thus, limit the functionality of the application programs.

With touch screen user interfaces, the user may touch and drag, or “flick” an object to change the object directly. It is common to scroll objects and navigate through pages of information as well as to give the object a command. However, it is not common to be able to give the object a multitude of different commands, beyond the direction of a scroll or navigation. A plurality of buttons is commonly used when a plurality of different commands for the object may be presented to the user. However this takes up valuable screen space. If many buttons are required, sometimes called keys, then the size of each button, or key, will have to be very small. This makes it hard for the user to use the button, or key, with accuracy.

Many portable computing devices contain keyboards. Keyboards consist of a collection of buttons that are commonly called keys. The keyboards on many portable computing devices often have a minimum of keys with one or more keys to switch the set of commands that the keys generate. An example of this is the common “shift” key. Whether the keyboards are physical keyboards or touch screen keyboards, they are being condensed in size to the point where it becomes difficult for the user to press a desired key without inadvertently pressing an unintended key. Further, users of portable computing devices generally hold the device with one, or both, hands while using the keyboard. This limits the user to using less than all fingers to operate the keyboard. Users generally use one or more fingers of one hand, or both thumbs of both hands. The limited size of keyboards on portable computing devices, along with the users using a limited number of fingers to operate the keyboards, make touch typing nearly impossible for the user. This makes typing on portable computing devices difficult. The user not only has to look at the keyboard when typing, but the user has to look at the text being entered to see the typing mistakes. Most of the mistakes made are due to the small size of the keys on the keyboard, and the user typing with a limited number of fingers. After a mistake has been made, the user then has to correct the typing mistake, which generally requires the user to also look at different places on the screen and keyboard. Every time a mistake and subsequent correction is made, it takes significant time to correct. Reliably translating a user's intended input, through buttons and the like, into device commands is very important to the user's satisfaction in using a computing device.

Several solutions have been proposed, and implemented to try and improve typing with small keyboards. One such example are keyboards that allow a user to touch a key on a touch screen keyboard, and then to swipe the users finger across each letter of the word before lifting the touch when the last letter has been touched. This is the method of operation of keyboards such as Swype (U.S. Pat. No. 7,808,480 Gross, U.S. Pat. No. 7,098,896 Kushler, http://www.swypeinc.com/), Shapewriter (U.S. Pat. No. 7,895,518 Kristensson, http://www.shapewriter.com/), and SlidelT (U.S. Pat. No. 7,199,786 Suraqui, http://www.mobiletextinput.com/Download/).

To operate these swiping keyboards, the user still has to slide his finger over each letter of a word. These keyboards have a similar number of keys to a conventional touch keyboard and, thus, have similarly sized small keys. Sliding a finger across a key is in no way more accurate than simply taping each letter of a word. Accordingly, the swiping keyboards heavily rely on predicting what the user intended to type. While predictive technologies improve a user's experience by predicting correctly more often than not, prediction has an associated error rate. Predictive corrections force a user to correct whole words instead of individual characters of a word. This represents no overall improvement to the user.

A method to enhance typing on a small keyboard is to use a smaller number of keys. One technology to use this strategy is the T9® text input system (U.S. Pat. No. 5,818,437 Grover). In this system, the user presses a key that represents more than one character. After pressing the keys that have the characters on them that comprise a word, the system decodes the keys pressed and enters the word that it thinks that the user was intending to type. This method, of course, has a high error rate as more than one word can be represented by the same sequence of key presses. A high error rate is obviously undesirable to the user.

Another keyboard to use a smaller number of keys is MessagEase (U.S. Pat. No. 6,847,706 Bozorgui-Nesbat, www.exideas.com). It uses only nine keys, in a 3 by 3 grid, to contain all the letters of the alphabet. A user types with MessagEase by entering individual characters with either a tap of a key, or by touching a key, and then sliding a finger across to be released on another key. This allows a single key that is larger than a convention key, for a given keyboard size, and yet lets the user select from multiple keystrokes choices, unambiguously, from a single key. This represents an improvement to the user, as the larger keys can be pressed by the user with a lower error rate than the small keys of a conventional keyboard. However, the keys of MessagEase require the user to slide, or swipe, a specific distance and direction to select certain characters. The distance must be enough to leave the key that the user initially pressed and not so far as to pass the adjacent key. Further, the MessagEase keys may only be swiped in the direction of an adjacent key, which limits the number of character choices that can be selected with an initial key press. Further, the keyboard layout of MessagEase does not resemble a conventional keyboard layout, which limits market acceptance.

Another keyboard that uses a limited number of keys is the Tiki6Keys® keyboard (http://tikilabs.com/index.php?p=home). This keyboard provides different modes of use. In one mode, the user is required to press multiple keys to enter a character. This obviously slows text input verses a conventional keyboard that only requires a single key press. In another mode, the user may press a key and then slide to another key to enter a character. This is similar to MessagEase and has the same limitations.

On small devices, keyboards generally have the requirement of needing to give the user a reliable selection method between many choices, as there are many characters in a language. Due to this, many creative solutions have been tried for small keyboards with varying degrees of success. However, user input objects that can quickly enable a user to input a multitude of commands, or characters, within the small confines of a small space can be useful in many applications, beyond keyboards. What is needed is a button, menu, or key, that can reliably generate more than one command with high reliability and little user motion and effort. A preferred solution has been described in U.S. Provisional Patent Application 61/396,261 (May 24, 2010) (to the inventor of the present invention), to which the present application claims priority.

### BRIEF DESCRIPTION OF THE DRAWINGS

For a better understanding of the embodiments of the invention, as well as additional embodiments thereof, reference should be made to the Description of Embodiments below, in conjunction with the following drawings, in which like reference numerals refer to corresponding parts throughout the figures.

FIG. 1 is a perspective view of the device of FIG. 3A.

FIGS. 2A, 2B, 2C, 2D, 2E, and 2F illustrate an example of a user input sequence as processed by some methods of the invention.

FIGS. 3A and 3B are front views of an electronic device in accordance with some embodiments of the invention.

FIGS. 4A and 4B illustrate some methods of the invention.

FIG. 5A illustrates some methods of some embodiments of the invention.

FIG. 5B illustrates some methods of some embodiments of the invention.

FIGS. 6A, 6B, 6C, and 6D illustrate some methods of the invention.

FIGS. 7, 8, 9, 10, and 11 illustrate some embodiments of the invention.

FIGS. 12 and 13 illustrate some methods of the invention.

FIGS. 14 and 15 illustrate some methods of some embodiments of the invention.

FIG. 16 illustrate some embodiments of the invention.

FIG. 17 is a front view of an electronic device in accordance with some methods of some embodiments of the invention.

### REFERENCE NUMERALS IN DRAWINGS

10 Computing Device
11 Status Bar
12 Text Entry Area
13 Home Button
14 Software Keyboard
15 Software Keyboard
16 Display Screen
20 Multidirectional Button
21 System Pointer
22 Button Boundary
24 Initial Press Position
26 Displayed Multidirectional Button
28 Motion Threshold
30 Multidirectional Button
31 Multidirectional Button
32 Multidirectional Button
33 Button Boundary
34 Button Boundary
35 Button Boundary
36 Multidirectional Button
37 Multidirectional Button
38 Multidirectional Button
40 Selection Point
41 Selection Region
42 Selection Region
43 Selection Region
44 Selection Region
45 Second Motion Threshold
46 Button Boundary
47 Button Boundary
48 Button Boundary
60 New Press Position
61 Selection Region
62 Selection Region
63 Selection Region
64 Selection Region
65 Press Position
66 Secondary Multidirectional Button
68 Secondary Motion Threshold
70 Keyboard Layout
80 Keyboard Layout
81 Selection Region
82 Selection Region
83 Selection Region
84 Selection Region
85 Selection Region
86 Selection Region
87 Selection Region
88 Selection Region
90 Number Pad
100 Number Pad
110 Keyboard Layout
120 Secondary Multidirectional Button
130 Sub Multidirectional Button
140 Multidirectional Button
141 Selection Region
142 Selection Region
143 Selection Region
144 Selection Region
145 Selection Region
160 Keyboard Layout
170 Multidirectional Button
171 Multidirectional Button
172 Multidirectional Button
173 Multidirectional Button
174 Multidirectional Button
175 Multidirectional Button
176 Multidirectional Button
177 Multidirectional Button
178 Multidirectional Button

### DETAILED DESCRIPTION OF THE EMBODIMENTS

Reference will now be made in detail to embodiments and methods of the invention, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known and/or common processes, programming methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms may only be used to distinguish one element from another. For example, a first motion could be termed a second motion, and, similarly, a second motion could be termed a first motion, without departing from the scope of the present invention.

The terminology, used in the description of the invention herein, is for the purpose of describing particular embodiments and methods only and is not intended to be limiting of the invention. As used in the description of the invention and the appended claims, the singular forms “a”, “an” and “the” are intended to include the plural forms as well, unless the context clearly indicates otherwise. It will also be understood that the term “and/or”, as used herein, refers to and encompasses any and all possible combinations of one or more of the associated listed items. It will be further understood that the terms “comprises” and/or “comprising,” when used in this specification, specify the presence of stated features, steps, methods, operations, elements, and/or components, but do not preclude the presence or addition of one or more other features, steps, methods, operations, elements, and/or components thereof.

Embodiments of a computing device, a user interface for such devices, and associated methods and processes for using such devices are described. In some embodiments, the device is a portable communications device with a touch screen display such as a mobile telephone that may also contain other functions, such as Web browsing, PDA, music player, and other functions as well as downloadable applications for unlimited functionality. In another embodiment the device is a keyboard.

For simplicity, in the discussion that follows, a computing device is used as an exemplary embodiment. It should be understood, however, that the disclosed multidirectional button, or key, user interfaces and associated processes may be applied to other devices, such as, but not limited to, computer keyboards, hand held electronic displays, personal computers, laptop computers, tablet computers, portable music players, GPS units, and electronic watches. The computing device may be capable of performing a plurality of tasks and are sometimes referred to as a “multifunction device”. For simplicity the computing device is sometimes simply referred to as “the computing device” or as “the device”.

A computing device may have one or more screens for the display of user viewable program content. The screens may be, but not limited to, side by side screens or screens on different sides of the device. For simplicity, the one or more screens currently viewable by the user may be referred to as the “display screens” or as the “display screen”.

For simplicity, the term ‘button’ will represent a physical button or a visual on-screen button drawn on the display screen. An on-screen button may be used with a pointing device or may be a touch screen button intended to be touched directly by the user. Buttons are user input objects and are means to issue user commands to the device.

In all figures that display an X, Y, Z axis legend, the X axis and the Y axis define a plane coincident with the plane of the top surface of one or more buttons. In all figures, the position of the buttons are illustrated as being on the top surface of a computing device 10, however, they need not be on the top surface. The buttons are all illustrated on the top surface of the computing device for simplicity. The Z axis is defined as perpendicular to the buttons with the positive Z direction extending upwards from the button. For simplicity, it is assumed that the positive Z direction points toward the user of the device, which assumes that the user is facing the display screen.

The term “user input” refers to the means by which the user uses the buttons. This may be accomplished by manipulating the buttons with the user's fingers. The user's input to the buttons may also be accomplished with, but not limited to, a stylus, a mouse, or any device whose output can be interpreted into presses, releases, and motion of the presses.

Common to all embodiments are means to sense user input and generate signals. The processing of the user input sensing signals and the means and methods to translate those signals into screen changes and device commands need not occur in the portable device that houses the display screen and/or multidirectional buttons of the invention. For example: press, release of the press, and motion of the press signals and the processing of the signals may be communicated to a processor outside of the portable device. The programming of the display may, likewise, be communicated from an outside processor. In the example portable device described herein, all means to sense user input signals and the means to translate those signals into screen changes and device commands are contained in the one portable device. However, the term “portable computing device” should be construed to comprise: one or more portable display screens, the means to sense user input signals and the means to translate the signals into commands, wherever the processing of the user input signals may take place.

Common to all embodiments and methods is a button, which will generally be referred to in this disclosure as a “multidirectional button”, “button”, or “menu” for simplicity, but may also be referred to as a “key”, “switch”, “toggle”, or “pick list”. The button detects user input presses and releases, as does a common button, but additionally detects user input motion or force in a direction substantially perpendicular to the direction of the press. The button generates and/or detects signals containing a direction and/or a value of the user motion or force in a direction substantially perpendicular to the direction of the press. For simplicity, the direction substantially perpendicular to the direction of the press may be referred to as the “lateral direction”. The buttons of the embodiments and methods of this disclosure detect button events that are comprised of presses, motions and/or forces, the exceeding of motion and/or force thresholds, and releases of the presses. The buttons of the embodiments and methods of this disclosure may additionally detect the exceeding of time thresholds as a button event. The methods and embodiments of the multidirectional buttons of this disclosure detect one or more button events to determine one or more commands for the device. The multidirectional buttons of this disclosure have a plurality of choices that the user may choose to enter a command into the device.

Common to all button methods is the means to detect user changes to input objects that comprise at least one multidirectional button. The input objects may be manipulated directly by the user if the objects are physical buttons. If the input objects are on-screen buttons they may be manipulated by a pointer and pointer controller buttons, which is commonly known as a mouse interface. If the input objects are on-screen touch screen buttons, the buttons may be manipulated by directly touching a touch screen. Many common means exist to process the signals and this invention should not be limited to one particular method. For example, the operating system may receive signals from the buttons and send messages to processes, or application programs. In another example, individual applications, or processes, may poll button devices for changes in the state of the buttons.

In an embodiment, the user presses one or more multidirectional buttons, moves the presses, and releases the presses to input commands into the device. Instructions for performing these functions may be included in a computer readable storage medium or other computer program product configured for execution by one or more processors. Instructions for performing these functions may apply one or more methods and heuristics to the motion of the presses to determine a command for the device, and instructions for processing the command.

In an embodiment, the button may be a physical button that can detect presses, releases, and force and/or motion in the lateral direction. The button may be movable or may detect force through means such as, but not limited to, strain gages. The lateral motion of the button or detected user applied force, in the X/Y plane in all figures, will be referred to in this disclosure as a “press motion”, and sometimes just called a “motion”. The user lifting one or more fingers from the physical button will be referred to as a “release”.

In a method of the invention, the user presses a physical multidirectional button to initiate a multidirectional button, or command, method. The button method comprises: receiving a first press signal that initiates the method; saving information about the press; detecting substantially lateral motion, or movement, of the button; detecting if the motion of the button has exceeded a motion threshold; detecting the release of the button; determining the direction of the motion of the button; and determining a command for the device, wherein the command for the device may be, but not limited to, the entry of keystrokes, any commands that are commonly issued by menus or buttons or other input objects, and/or the initiation of secondary button methods.

In an embodiment, the buttons comprise regions, or areas, of a display screen that the user may move a pointer over to initiate methods for generating user interface commands. Moving a pointer on the screen may be comprised of the user moving the pointer with a mouse or mouse substitute. The mouse, or mouse substitute, contains one or more buttons which are referred to as “pointer buttons”. The pressing of one or more of the buttons, while the pointer is over a button boundary, will be referred to as a “press”. Moving the mouse with one or more pointer buttons pressed down will be referred to in this disclosure as a “press motion”, sometimes just called a “motion”. The user releasing one or more of the pointer buttons will be referred to as a “release”.

In a method of the invention, the user moves a pointer, with a mouse or mouse substitute, on the display screen over a button boundary and presses a pointer, or mouse, button to initiate a multidirectional button, or command, method. The button method comprises: receiving a first press signal that initiates the method; saving information about the press; detecting motion, or movement, of the mouse, or mouse substitute; calculating displacement of the motion; determining if the motion has exceeded a displacement threshold; detecting the release of the pointer button; determining the angular displacement; and determining a command for the device, wherein the command for the device may be, but not limited to, the entry of keystrokes, any commands that are commonly issued by menus or buttons or other input objects, and/or the initiation of secondary button methods.

In an embodiment, the buttons comprise regions, or areas, of a touch screen display that the user may touch to initiate methods for generating user interface commands. The touching of the screen may be comprised of the user touching the touch screen with one or more fingers or other parts of his hands or body. Or the touching of the screen may be comprised of the user touching the touch screen with one or more objects, such as, but not limited to, a stylus. For simplicity, it is assumed that the user uses his fingers to touch the screen for this disclosure. The initial touch of the touch screen will be referred to as a “press”. The user may slide one or more fingers across the touch screen while maintaining contact with the screen. This is commonly referred to as a “flick” or “swipe” and will be referred to in this disclosure as a “press motion”, sometimes just called a “motion”. The user lifting one or more fingers from the screen will be referred to as a “release”.

With touch screen user interfaces, the user may touch and drag, or “flick” or “swipe” an object to change the object directly. It is common to scroll objects and navigate through pages of information, as well as to give the object a command directly. However, it is not common to be able to give the object a multitude of different commands, beyond the direction of a scroll or navigation. In a difference between the user manipulating an object directly, and a button object, the user manipulates a button to issue a command to the object indirectly, or to the device indirectly. In a multidirectional button, the user manipulates a multidirectional button in able to choose between more than one command for the object, and/or the device. The advantage of a multidirectional button is to give the user a choice of commands from a single button object.

In a method of the invention, the user touches a touch screen within a button boundary to initiate a multidirectional button, or command, method. The button method comprises: receiving a first touch press signal that initiates the method; saving information about the touch press; detecting motion, or movement, of the touch; calculating displacement of the touch; determining if the touch has exceeded a displacement threshold; detecting the release of the touch; determining the angular displacement; and determining a command for the device, wherein the command for the device may be, but not limited to, the entry of keystrokes, any commands that are commonly issued by menus or buttons or other input objects, and/or the initiation of secondary button methods.

In an aspect of the invention, the multidirectional button method may also detect, but not limited to: further user presses; the positions of the presses; and the time of the presses in some data variables; whereby the button method may determine one or more commands for the device.

In an aspect of the invention, a multidirectional button method may determine the angular displacements of the one or more presses from the initial press position and the press position at the time of release, or the press position at the time the press motion exceeded a motion threshold, or at another time. The user of a multidirectional button will, most likely, not move a press in a single direction. For instance, if a user touches a touch screen with his finger and flicks his finger in a direction, the motion will likely follow a substantially arc shaped curve as his finger rotates about his finger joints. The most accurate method of interpreting a user's intended motion may depend on the user's style and skill. A multidirectional button may vary its behavior based on data values, and/or settings, which may, or may not, be user configurable. Configuring behavior of a user input object, software method, or process, and allowing a user to change settings affecting the behavior is common in computing devices. A multidirectional button method may read one or more stored data values to determine how to handle button events. For instance, the multidirectional button method may choose which method to use, from a data value, to calculate the angular displacement.

In a method of the invention, the user touches a touch screen within a button boundary to initiate a button, or command, method. The button method comprises: receiving a first touch press signal that initiates the method; detecting further touch presses; saving the position of the one or more touch presses and/or the time of the press in some data variables; detecting motion, or movement, of the touches; calculating displacements of the touches; determining if a touch has exceeded a displacement threshold; detecting the release of the touches; determining the time of the release if more than one press was detected; determining the position of the touch at the time of release of the touch; calculating the angular displacement from the initial touch position and the release touch position; determining a command for the device, wherein the command for the device may be, but not limited to, the entry of keystrokes, any commands that are commonly issued by menus, and/or the initiation of secondary button methods.

Common to all embodiments that use pointer based user input, and touch screen based user input based on a user press and movement of the touch, is the calculation of the displacement of the motion of a pointer or touch. The displacement of a touch is the distance the user's finger, or stylus, has moved along a display screen from an initial screen contact point to a current screen contact point. The displacement of a pointer is the distance the pointer has been moved along a display screen from an initial position to a current position. The term displacement will be used instead of distance as the distance the motion of the press or touch has traveled to reach a displacement is insignificant.

The operating systems of portable devices commonly provide signals which include positional information of a pointer position or a touch. The position data is generally given in X and Y coordinates, commonly known as the Cartesian coordinate system. However, position data may be provided in other ways such as an angle and displacement from a reference point, commonly known as the Polar coordinate system. The position information may be in terms of a pixel location on the screen or in terms of a global coordinate system that may be translated from the coordinates of the current screen, or a section of the screen.

Calculating a displacement with Cartesian coordinates may be accomplished by applying the Pythagorean Theorem to an initial pointer or touch position and a current pointer or touch position. Assuming that the device is providing pointer or touch position signals with X and Y data values, calculating the displacement is accomplished by taking the square root of the addition of the square of the difference of the initial and current pointer or touch position X values and the square of the difference of the initial and current pointer or touch position Y values. Calculating pointer or touch displacements is common knowledge in the art.

Finding the angle of a current pointer or touch position from an initial pointer or touch position is a simple matter of using the inverse tangent function with the differences of the X and Y initial and current components. This is common geometry and common knowledge in the art.

Finding displacements and angles from an initial position to a current position is also common knowledge for Polar coordinates.

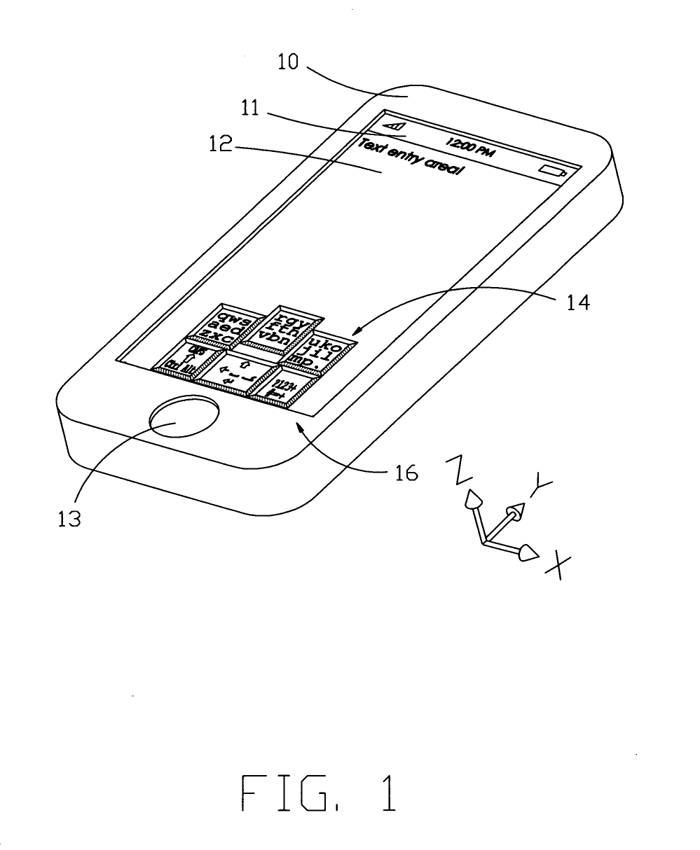

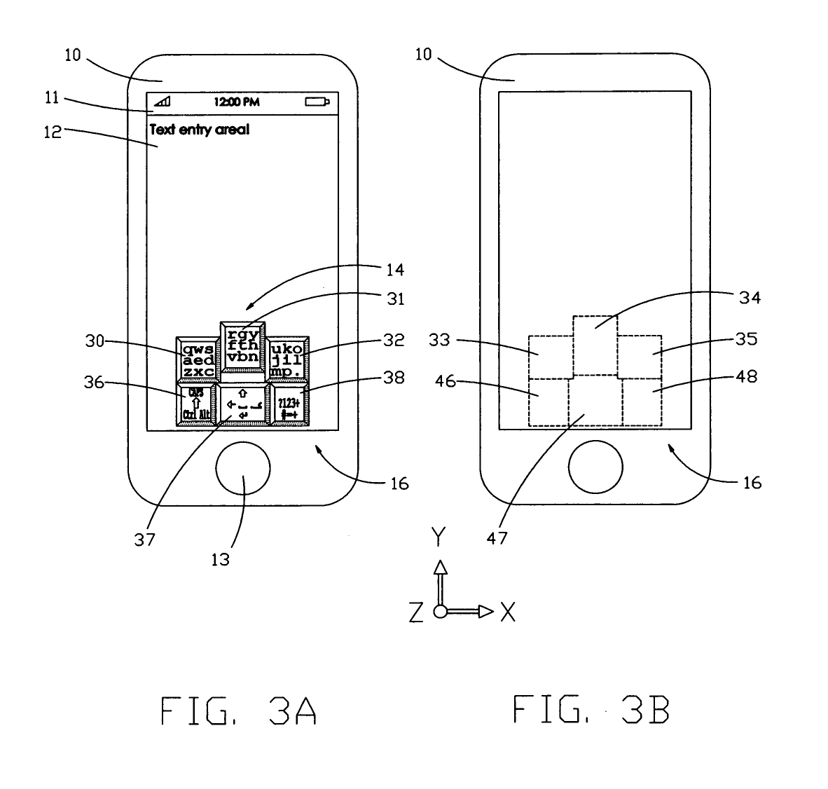

FIG. 1 is a perspective view of the device of FIG. 3A and illustrates a portable computing device 10 with touch screen display 16 in accordance with some embodiments. The portable computing device resembles a popular smart phone and contains a status bar 11 and a home button 13 for visual orientation. The touch screen display contains an on-screen keyboard 14 in accordance with some embodiments. The on screen keyboard is comprised of a plurality of multidirectional buttons. The buttons contain as many as nine different user selectable choices within one press, motion or no motion, and one release.

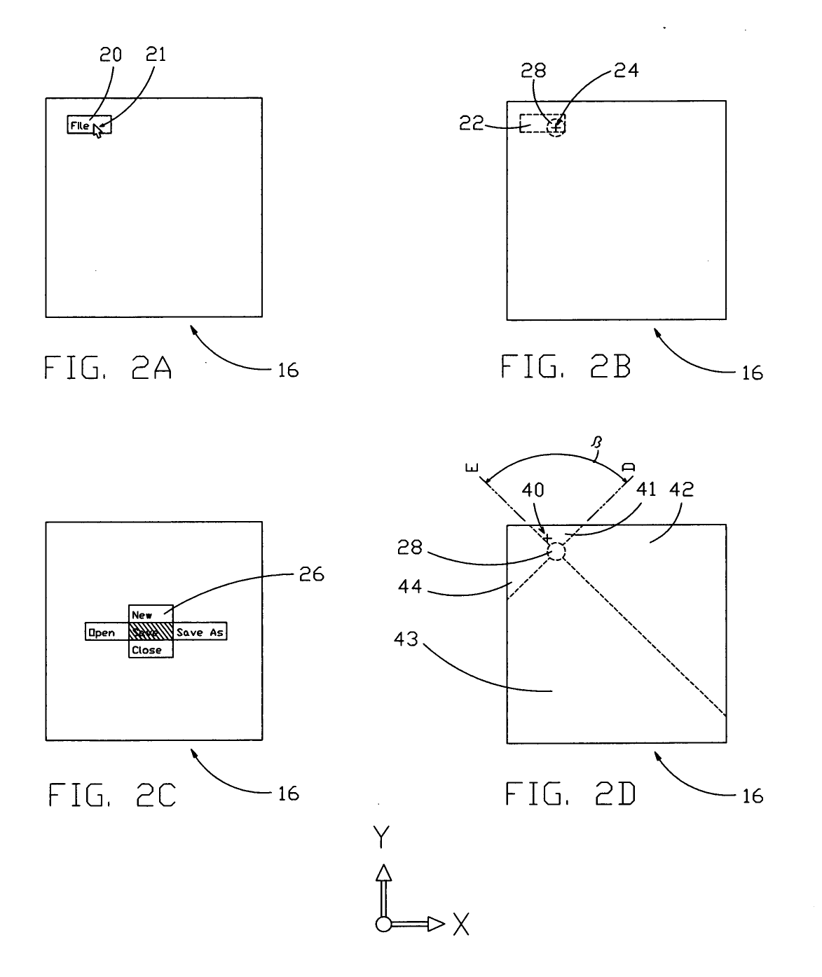

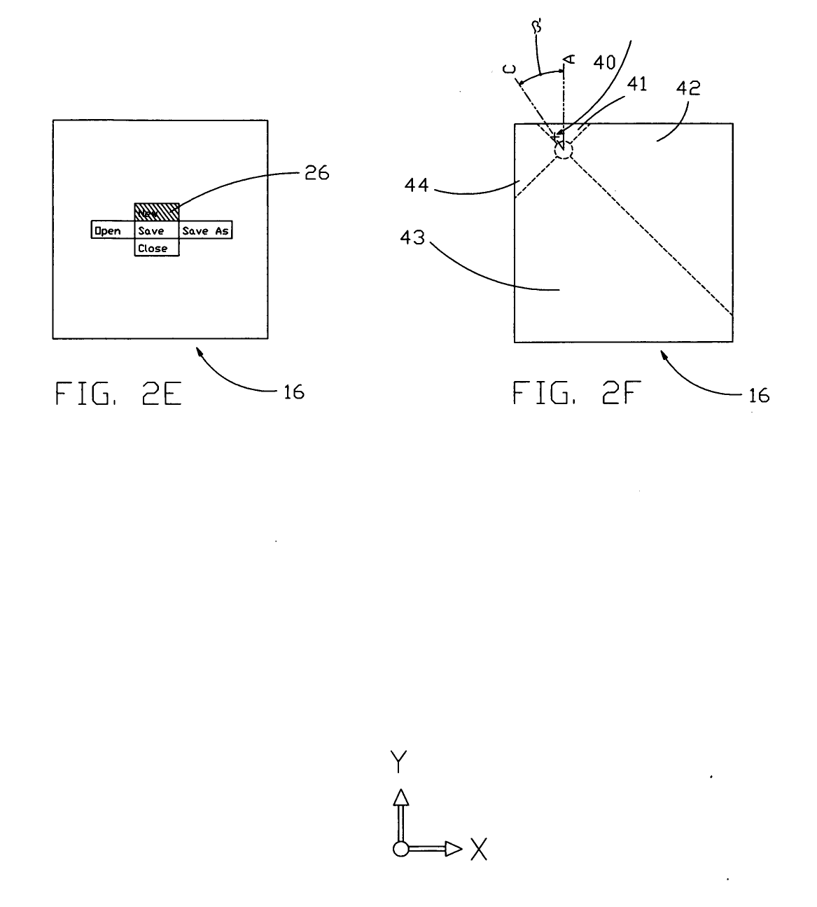

FIGS. 2A, 2B, 2C, 2D, and 2E illustrate an example sequence in which a user selects one command from a plurality of commands that may be selected from a multidirectional button in order to illuminate the operation of multidirectional buttons. FIGS. 2A, 2C, and 2E illustrate what is displayed to the user on a display screen 16. FIGS. 2B and 2D show positions of boundaries and thresholds and touch points on the display screen. (The “touch point” is the point on the screen where a user is touching a touch screen, or the point where the pointer is when a mouse button is pressed.) FIGS. 2B and 2D do not display the content that the user sees on the display screen in order to not obscure these objects. The positions of boundaries and thresholds and touch points are not displayed to the user but are shown only to illustrate methods of enabling a user to select from a plurality of choices from a button. The bounding button areas are the areas of a display screen that will initiate the methods of this disclosure for on-screen directional buttons, when pressed by the user.

FIG. 2A illustrates a display screen 16 which is displaying an example of a single multidirectional button 20. The display of the multidirectional button, which is what the user sees, appears as a common button or menu item. If the button is to be selected with a pointer 21, the user places the pointer over the button and presses a pointer, or mouse, button. If the button is to be selected with a touch on a touch screen, the user will directly press the button on the touch screen. The button press initiates a button method for determining a command from a sequence of user motions and releases.

FIG. 2B illustrates a button boundary 22 which represents the portion of the display screen 16 within which a press 24, or touch, will initiate a multidirectional button method. The press 24, initiating the button method, is represented by a small cross. Upon receiving a press signal or message initiating a button method, the method detects motion of the press and checks for motion exceeding a motion threshold 28. In this example, the button threshold represents a displacement threshold of press motion from the initial press position 24. As such, the motion threshold is represented by a circle centered on the initial press position.

In an aspect of the invention, the motion threshold need not be directly related to motion of the press, but may be a threshold value based upon the signal of the pointer or touch motion.

Once the user press has occurred within a button boundary, this example button method changes what is displayed to the user, as illustrated in FIG. 2C. In this example button, five command choices are now displayed. The center choice of the displayed multidirectional button 26 is highlighted, as the button method has just been initiated and press motion beyond the motion threshold has not yet been detected. If the user were to release the press at this time, without press motion beyond the motion threshold, the button method would issue a command associated with the center choice to the device.

In an aspect of the invention, button methods may or may not change what is displayed to the user when the user presses a button. Further, button methods may or may not change what is displayed to the user when the user moves the press past motion or time thresholds. Further, button methods may use any common methods to display choices and highlight current selections of the choices.

In an aspect of the invention, button methods may place what is displayed to the user anywhere on the display screen. In this example, the button method has placed the displayed multidirectional button 26 near the center of the display screen 16. The display of this button is not displayed directly under the press, or touch, so that the user's finger does not obscure the user seeing the choices that are now displayed.

FIG. 2D illustrates the next step in the sequence of the user selecting a command from the multidirectional button. In this step, the user has moved the press 40 beyond the initial motion threshold 28. In a difference between common button behavior and a multidirectional button, the button boundary that initiated the button method is no longer significant. If the user moves the press to a selection other than the center selection, or choice, the displacement of the press need not exceed the button boundary but needs to exceed the motion threshold. The button method, upon detecting that the current position of the press has exceeded the motion threshold, determines which selection region currently contains the current press position. Software methods for making this determination are common and may be accomplished by many methods. In this example, the angle of the displaced press, from the initial press position (β′ in FIG. 2F), is compared to four angular selection regions 41, 42, 43, and 44. (As can be seen in FIG. 2F, β′ is the angle between axis A, which is in the Y direction, and axis C, which passes through the current press point and the initial press point.) In this example, each of the four selection regions has an angular aperture β of 90 degrees. (As can be seen in FIG. 2D, β is the angle between axis D and axis E.)

In an aspect of the invention, the angular aperture of selection regions need not be at regular intervals. Certain user input motions may be more accurate than others. For example, a programmer may implement a multi-direction button with larger selection region angular apertures for motions that are harder for the user to reliably execute.

In an embodiment of the invention, a process may create a database tracking user input errors and adjust selection region apertures and/or motion thresholds and/or time thresholds based on the error rate of selecting certain commands. The rate of user error may be kept track of by common methods such as, but not limited to, tracking the commands that were issued prior to a backspace, or other error correction commands. The user input errors may be determined by comparing the command entered by the user following a correction command and comparing the command with the command entered prior to the correction command. The prior, correction, and corrected commands may be comprised of pluralities of device commands.

In the example user input sequence illustrated in FIG. 2D, the button method has detected that the press is now in selection region 41. In this example, the button method updates the display screen 16, as seen in FIG. 2E, to highlight the top menu item.

The last step of the user input selection sequence is the user releasing the press. Upon detection of the release, the method issues one or more commands. This example method then updates the screen to remove the popup multidirectional button, or menu, display.

In an aspect of the invention, software methods may implement algorithms to determine that the command that can be selected by the user, or highlighted, is associated with a selection region neighboring the selection region that a press is currently in. Users will most likely not move a press in a straight line, as their fingers are composed of pivots that tend to produce arcing motions. As such, a variety of methods may be chosen from to determine the direction the user intended to move a press. For example, the angle of press motion at the time the press exceeded a motion threshold may be averaged with the angle of the release of the press. In another example, the initial motion of the press may be weighted more highly than more recent motion.

In Microsoft's Windows operating systems, the right mouse button ‘pop's up’ a menu in many applications. In an aspect of the invention, the multidirectional buttons of this disclosure may likewise ‘pop up’ in response to a user press, be it the press of a mouse button or the touching of a touch screen or the press of a physical button. An initial on-screen button need not be displayed to the user.

In an aspect of the invention, any number of angular apertures of selection regions may exist in any multidirectional button. There is no theoretical limit to the number of selections and commands that can exist in a multidirectional button as the angular selection regions can be infinitely small. However, the practical limit is the minimum angular aperture that defines a selection region into which the user can reliably move a press.

In an aspect of the invention, the selection regions need not be at regular angular intervals or symmetrically placed around the motion threshold. Multidirectional buttons may have selection regions that adapt to suit the needs of the application that control them.

### Detailed Description of a Keyboard Comprised of Multidirectional Buttons

In another embodiment, a plurality of multidirectional buttons comprises a keyboard. FIG. 3A illustrates an example computing device 10 containing a software keyboard 14. A software keyboard, sometimes called a “soft keyboard”, is a keyboard without physical keys. The keyboard may be a touch screen keyboard or may be operated with a pointing device, or stylus, or any common method of operating an on-screen software keyboard. Software keyboards are common on small portable computing devices which do not always have the room for a physical keyboard.

The multidirectional button keyboard of this example has a plurality of multidirectional buttons, of which three of the multidirectional buttons contain all of the alphabetical letters, of a single case, of the English alphabet. Each of these three buttons is a multidirectional button with nine key choices per button.

FIG. 3B illustrates the button boundaries of the multidirectional buttons of the software keyboard on the display screen 16 of the example computing device 10. Button boundaries 33, 34, and 35 are the boundaries of multidirectional buttons 30, 31, and 32 respectively which contain all 26 characters of the English alphabet. Button boundaries 46, 47, and 48 are the boundaries of multidirectional buttons 36, 37, and 38 respectively which contain other common keys, or commands, found on a common keyboard.

In an aspect of the invention, the methods implementing the software keyboard may track user press positions within the button boundaries, and or user press errors, and adjust the positions of the button boundaries to adjust to user preferences or use patterns.

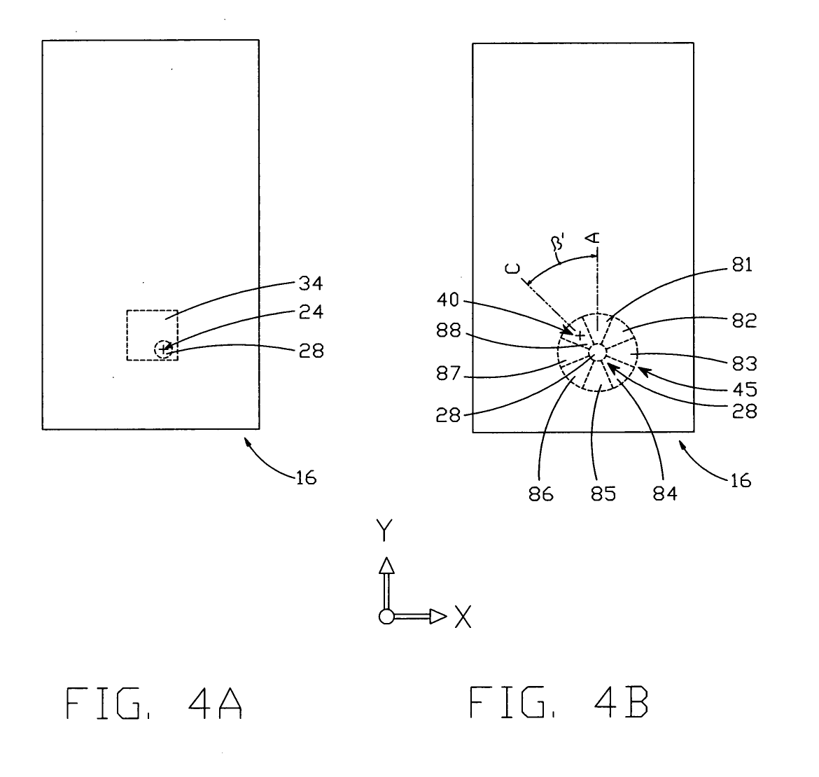

FIGS. 4A and 4B illustrate an example sequence in which a user selects one command from a plurality of commands that may be selected from a multidirectional button in order to illuminate the operation of multidirectional buttons. In this example sequence, an alphabetic character is entered into the computing device by a user. FIGS. 4A and 4B show positions of button boundaries and press motion thresholds and press, or touch, positions on the display screen without displaying the content of the display that the user sees. The positions of boundaries and thresholds and press positions are not displayed to the user but are shown only to illustrate methods of enabling a user to select from a plurality of choices from a single button. The button boundary areas are the areas of a touch screen that will initiate the multidirectional button methods of this disclosure for on-screen multidirectional buttons when selected by the user.

The first step of the example sequence consists of a user press within a button boundary 34. FIG. 4A illustrates the initial press position 24, represented by a small cross, within the button boundary 34. The button boundary corresponds to the upper center button on the software keyboard 14, as illustrated in FIG. 3A. Upon receiving a signal or message initiating the button method, the method detects motion of the press and checks for motion exceeding a motion threshold 28.

In this example method, the user's finger, or other selection device, is over the displayed on-screen button obscuring the displayed button. In this example method, the button, as displayed on screen does not change as the change would not be seen by the user.

In an aspect of the invention, the current key, or command, that would be selected if the user were to immediately release the press could be displayed anywhere on the computing device.

The second step in the example sequence is the user moving the press from the initial press position to a new selection point 40, as illustrated in FIG. 4B. In this example, each of the eight selection regions 81-88 has an angular aperture of 45 degrees. The new selection point has exceeded the motion threshold 28 for this button method. In this example, the angle of the displaced press, from the initial press position is angle β′. (As can be seen in FIG. 4B, β′ is the angle between axis A, which is in the Y direction, and axis C, which passes through the current press point and the initial press point.) The multidirectional button method of this example compares angle β′ to the eight angular selection regions to determine which selection region the press has been moved into.

In an aspect of the invention, the angular aperture of selection regions need not be at regular intervals but may be of any angular aperture and thresholds that suit a particular purpose.

The software keyboard 14, illustrated in FIG. 3A, shows multidirectional buttons with a variety of command selection choices. In this embodiment of a software keyboard, multidirectional button 36 has four command choices, multidirectional button 37 has five command choices, and multidirectional button 38 has two command choices.

In an aspect of the invention, the application program, or process, implementing a multidirectional button may reconfigure a multidirectional button at any time. For instance, command choices could be added, or subtracted, from the buttons.

In an aspect of the invention, multidirectional buttons need not be limited to a single command per selection, but may issue multiple commands or initiate other methods. For example, in the multidirectional button 37 illustrated in FIG. 3A, the command issued by the user choosing the right selection, or choice, would initiate a method that comprises the period character being entered into the device, followed by the space character being entered into the device, followed by the capitalization of the next key entered.

In an aspect of the invention, a command to be entered into the device may be comprised of a state change. For example, the lower left multidirectional button 36 of the software keyboard contains four selection choices comprising the common keyboard state changes: the Caps Lock key, the Shift key, the Control key, and the Alt key.

In a method of the invention, the Shift key may be pressed twice to toggle the “Caps Lock” state between on and off.

In the current example method, the example multidirectional button has a second motion threshold 45. If the user moves the press beyond the second threshold, no commands will be issued and the method will move buttons of the software keyboard to a new position on the display screen. In this way, the user can easily move the keyboard on screen to adapt to the user.

In an aspect of the invention, the multidirectional buttons that comprise a software keyboard may be moved, or positioned, on the display screen to match the user's style of typing. For instance, the user may switch from using the keyboard with one finger, or input device, to using the keyboard with a plurality of fingers, or input devices. The optimal button layout on the display screen will be different for the different ways in which a user chooses to use the keyboard.

In an aspect of the invention, on a touch screen, the user may touch the screen with more than one finger concurrently. This is known in the art as “chording”. If a user is using a mouse with buttons, pressing more than one mouse button at a time is also referred in the art as “chording”. Chording may be used to expand the number of command choices available to the user.

In a method of the invention, a multidirectional button method detects chording. Chording may be detected in the following ways: A multidirectional button method, after being initiated by a signal responding to an initial button press, detects press signals generated by one or more user presses subsequent to the initial press. The subsequent user presses may be comprised of the user touching the touch screen with another finger, or fingers, and/or the user pressing another button, or buttons, which may or may not be multidirectional buttons. The user presses may be comprised of the user pressing more than one mouse buttons while the system pointer is over a multidirectional button. The user presses may be comprised of the user pressing a plurality of physical multidirectional buttons. Upon detection of a press, the multidirectional button method detects further presses, motion of the presses, and releases to determine a command for the device.

In an aspect of the invention, a button method, upon detection of another press, may initiate another button method to interpret a user sequence of presses, motions, and releases to determine a command for the device.

In an aspect of the invention, a multidirectional button method may set timers and/or record the time of presses to differentiate between user intentions. For example, a plurality of buttons pressed or released within a time threshold could be interpreted as a simultaneous multi-button user press or release.

In a method of the invention, as illustrated in FIG. 1 and FIG. 3A, a multidirectional button method detects two user presses, within a time threshold, on the software keyboard 14 on the display screen 16 of the computing device 10. The method, upon detection of user releases of the presses, enters a “space” key command to the device.

In a method of the invention, as illustrated in FIG. 1 and FIG. 3A, a multidirectional button method detects two user presses on the software keyboard 14 on the display screen 16 of the computing device 10. The method, upon detection of user releases of the presses, within a time threshold, enters a “space” key command to the device.

Common keyboards allow a user to enter multiple keystrokes, or commands, by pressing a key, or button, and holding it down. A common process starts a system timer, when the press of a key is detected, that sends a timer signal to the process at a set interval, or rate of time. If the timer signal is received, prior to the detection of the release of the pressed key, the process enters a keystroke, or command, into the device. Upon detection of the release of the press, the process turns the system timer off.

In a method of the invention, a multidirectional button method starts a system timer, when the press of a multidirectional button is detected and/or a button press has exceeded a motion threshold. The system timer sends a timer signal to the button method at a set interval, or rate of time. If a timer signal is received, prior to the detection of the release of the pressed key, the process enters a keystroke, or command, into the device. Upon detection of the release of the press, the button method turns the system timer off. Whereby, the user may enter a plurality of commands into the device.

In an aspect of the invention, multidirectional button methods may change other buttons, or objects, or the display of other buttons, or objects on the display screen.

In a method of the invention, a multidirectional button method, initiated by an initial button press, changes the button display and processing of one or more buttons. The method, upon detection of a second press, a motion of the second press if any, and the release of the second press prior to the release of the press that initiated the method, enters a command into the device. Upon release of the initiating press, the command that would be entered into the device, if the second press had not been detected, will be suppressed.

In a method of the invention, a multidirectional button method, initiated by an initial button press, changes the button display and processing of one or more buttons to display alphabetical characters of the opposite case. The method, upon detection of a second press and a motion of the second press, if any, prior to the release of the press that initiated the method, enters one or more characters into the device. Upon release of the initiating press, the command that would be entered into the device, if the second press had not been detected, will be suppressed.

For example, if one of the three buttons 30, 31, and 32 of software keyboard 14 of FIG. 3A is pressed by the user, a multidirectional button method, upon detection of the button press, may change the other two buttons to display and process characters of the opposite case. FIG. 5A illustrates an example user press 24 on multidirectional button 32. (The characters that the user sees on button 32 have been removed from the drawing so the reader can see the initiating button press 24 and motion threshold 28.) As the reader can see, the case has changed from the lower case characters seen if FIG. 3A to uppercase characters on multidirectional buttons 30 and 31 illustrated in FIG. 5A.

In an aspect of the invention, the second press may have to occur beyond a threshold of time after the press initiating the multidirectional button method for the method to change the case of the other buttons.

In a method of the invention, a multidirectional button method detects motion of an initiating press beyond a motion threshold, and/or a press exceeding a time threshold, and changes other buttons or objects, which may or not be multidirectional buttons. The changes are comprised of, but not limited to, the replacement of a screen object with another object which may be a multidirectional button, changing the commands issued by a multidirectional button, and/or changing multidirectional button boundaries, motion thresholds, and/or time thresholds, and/or the display of a multidirectional button, or other screen object on the display screen. Multidirectional buttons contain pluralities of command choices and the choices may initiate more multidirectional buttons.

In another example, if one of the three buttons 30, 31, and 32 of software keyboard 14 of FIG. 3A is pressed by the user, a multidirectional button method, upon detection of the button press, may change the other two buttons to display and process non-alphabetical characters in place of alphabetical characters. FIG. 5B illustrates an example user press 24 on multidirectional button 32. (The characters that the user sees on button 32 have been removed from the drawing so the reader can see the initiating button press 24 and motion threshold 28.) In this example, the user has moved the press beyond the motion threshold 28. The method, upon detection of the press exceeding the motion threshold, has changed multidirectional buttons 30 and 31 to display and process non-alphabetical characters which comprise a number pad, as illustrated in FIG. 5B.

In an aspect of the invention, the second press may have to occur beyond a threshold of time after the press initiating the method.

In an aspect of the invention, the changing of the display of multidirectional buttons, that have had their commands changed, may not occur until a threshold of time has passed after the time of the press initiating the method.

In an aspect of the invention, the display of multidirectional buttons, that have had their commands changed, may not change if all presses are released within a threshold of time from the time of the press initiating the method.

In a method of the invention, the user pressing the software keyboard with two fingers and then moving the two presses in substantially the same direction, beyond motion thresholds, moves the keyboard on the display screen. Whereby, the user may move the keyboard to suit his typing style.

In a method of the invention, the user pressing the software keyboard with two fingers and then moving the two presses in opposite, and generally rotational, directions, optionally beyond motion thresholds, changes the orientation of the keyboard.

In a method of the invention, the user pressing the software keyboard with two fingers and then moving the two presses towards, or away from each other resizes the keyboard, and/or repositions buttons of the keyboard of the invention, and/or splits the keyboard into two or more sets of keys, or re-joins the two or more sets of keys into one keyboard.

For example, if the keyboard does not fill the extents of the width or height of the display screen, which it might not on a tablet computer, and the user presses on the keyboard with two fingers, the user could move his fingers apart to enlarge the keyboard. Further, if the user kept moving his fingers, past a set maximum enlargement, the keyboard could split into two sets of buttons, or keys, which, further, could contain copies of keys. The two sets of keys could then be positioned on opposite sides of the display screen. An embodiment of the invention comprising two or more sets of keys is illustrated in FIG. 17. In this provided example of the method, the user could change the keyboard from a smaller keyboard preferable for typing on with one hand, to two sets of keys that would be a preferable layout for the user using two hands to type. One such method of typing with two hands, that is preferable to have a split keyboard, is “thumb” typing.

FIG. 17 illustrates an embodiment of the invention. The device 10, of this embodiment, resembles a popular tablet computer. A Status Bar 11, Text Entry Area 12, and Home button 13 are shown for reader orientation. The display screen 16 contains a software keyboard of the invention comprising: two identical sets of multidirectional buttons, 14 and 15, which contain the alphabetical characters. As the reader can see in the illustration, the buttons 30, 31, 32, 36, 37, and 38 of the left set of buttons look and function identically to the buttons 170, 171, 172, 176, 177, 178 of the right set of buttons. Whereby the user may choose to type with the keyboard of this embodiment by holding the device in both hands and typing with his thumbs. The user can choose to type by using buttons of the right set, or left set, or a combination of the two sets of keys. The user may, thus, use the keyboard in a variety of ways, to his preference. This embodiment further includes a set of multidirectional buttons 173, 174, and 175, which contain the number pad, as well as other characters. These three buttons are centrally placed, and do not have copies on the display screen.

It is common in the art to split the keys of a common keyboard. However, splitting keys comprised of multidirectional buttons, as well as placing a plurality of copies of keys comprised of multidirectional buttons, or common keys, comprising alphabetical characters is novel and unobvious. A person skilled in the art could adjust the number, placement, display, and composition of the keys without departing from the scope of the invention. Further, the copied keys need not be identical, but could be similar while containing similar functionality.

In an aspect of the invention, the minimum displacement the user needs to move a press from the center selection area of a multidirectional button, which is the area within the motion threshold, is unrelated to the size of the button boundary. Further, the motion, or displacement, of the press required to pass a motion threshold is not based on the size or placement or shape of the multidirectional button on screen display, or graphic. A difference between multidirectional buttons and common menus, or buttons, is that the displacement of the press needed to exceed the motion threshold and move to another selection region may be less than the displacement needed to move from one similarly sized menu item to another. Further, the maximum displacement of a press need not be limited by an adjacent button boundary. The maximum displacement need only be limited by the extents of press motion, which on a touch screen is the screen boundary. On a common menu, or button, the user can often move between menu items, or adjacent buttons, by moving a press from one menu item, or button, to another, but the press must be over whichever menu item or button that is to be selected. An advantage of multidirectional buttons is that the user may be less accurate with a press motion.

In a traditional menu system, the user must be aware of the limits and selection boundaries of the menu item, or button, the user is selecting. In a pointer based user input system, the user must watch the pointer on the screen to see that it has moved over the menu item to be selected, and not beyond the menu item. In a touch based user input system, the user must likewise be aware of the placement of his fingers over the menu item to be selected, and not beyond the menu item. With directional buttons, the user only needs to watch the placement of the press. For the remainder of the methods of selection, the user only need to have a feel for how far the touch or pointer has moved, and in what general direction it has moved. In practice, the user of a multidirectional button will find it far easier to “touch type”, which is to say that the user may issue commands while not having to maintain visual contact with the button, or menu, interface.

Common to all embodiments that use pointer based user input, and touch screen based user input based on a user press and movement of the touch, is the detection of displacement of the pointer or touch that has exceeded threshold values. A threshold value may have one value if the threshold consists of a radius of displacement and the angle of the radius. A threshold consisting of a radius and angle defines a circular threshold area, assuming that the X and Y coordinates represent equal distances per unit. A threshold value may have a plurality of values needed to define other shapes. For example, a threshold value consisting of an X and a Y value will define a rectangular threshold area.

In an embodiment, a multidirectional button has a plurality of motion thresholds with increasing press motion displacements, from the initial press, required to move the press to new selection regions. For example, on a touch screen, the user may move his finger past a first press motion threshold and continue to move his finger past a second press motion threshold. The user may continue to move his finger past more motion thresholds limited only by the size of the display screen.

In an aspect of the invention, the methods and embodiments of pointer, touch, and physical multidirectional button based input need not be mutually exclusive in the computing device but may be implemented in any combination.

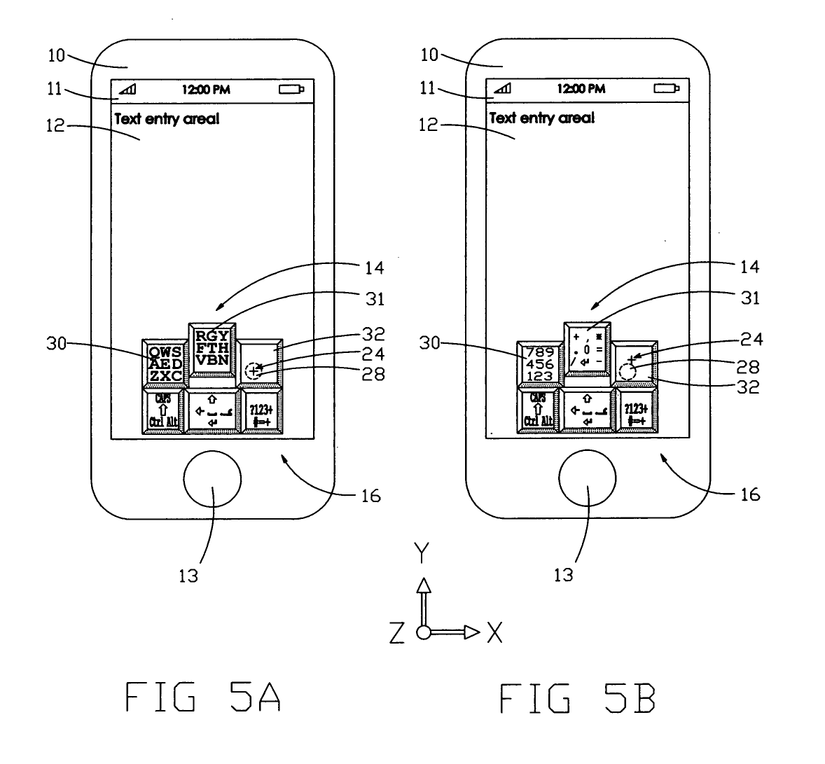

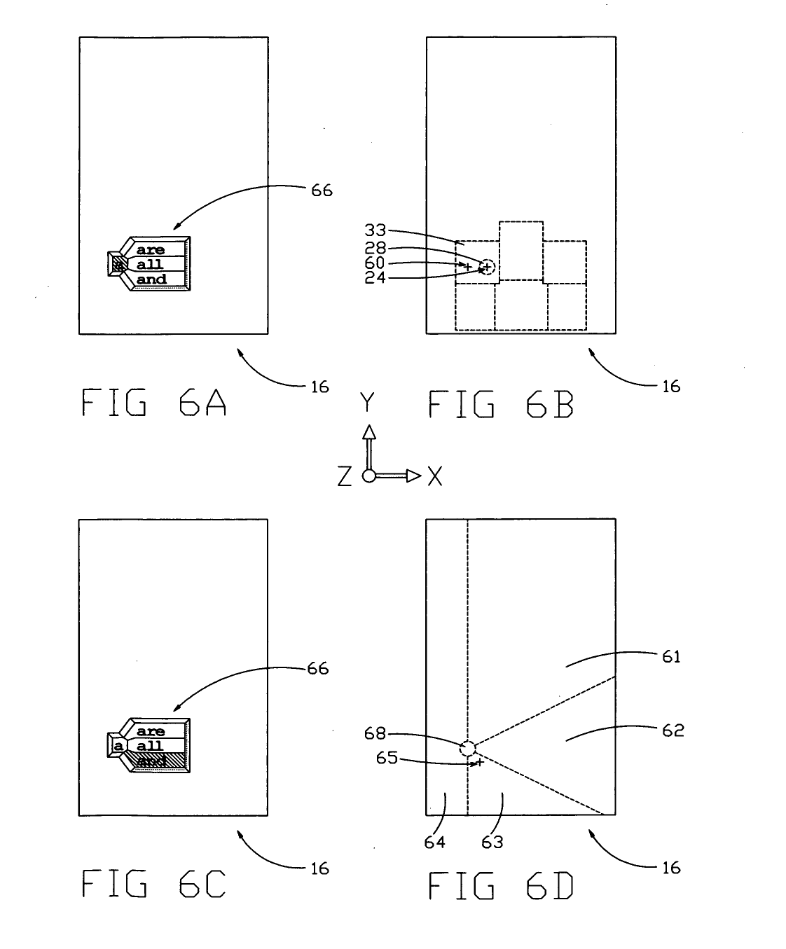

FIGS. 3A, 6A, 6B, 6C, and 6D illustrate an example sequence in which a user selects one command from a plurality of commands that may be selected from a multidirectional button in order to illuminate the operation of a multidirectional button that displays a second plurality of command choices. FIGS. 3A, 6A, and 6C illustrate what is displayed to the user on a display screen 16. FIGS. 6B and 6D show positions of boundaries, thresholds, and touch points on the display screen, without displaying the content the user sees. The positions of boundaries and thresholds and touch points are not displayed to the user, but are shown only to illustrate methods of enabling a user to select from a plurality of choices from multidirectional buttons. The bounding button areas are the areas of a touch screen that will initiate the methods of this disclosure for multidirectional buttons, when pressed by the user.

FIG. 3A illustrates a display screen 16 which is displaying an example of a software keyboard comprised of multidirectional buttons. In this example sequence, the first step is comprised of the user pressing button 30. Upon receiving a press signal, the example button method determines the initial press position 24, illustrated in FIG. 6B. The method then detects motion of the press to determine if the press has exceeded a first motion threshold 28, illustrated in FIG. 6B.

The second step of the example sequence is comprised of the user moving the press beyond the motion threshold to new press position 60. The method, upon detection of the press having moved outside of the first motion threshold, initiates a new multidirectional button. The method now highlights the current command that will be selected if the user releases the press, which in this case is the “a” key, as illustrated in FIG. 6A. In this example method, the method initiates the display and processing of a secondary set of commands. As can be seen in FIG. 6A, the original button, as displayed to the user, has been replaced by a secondary multidirectional button 66. FIG. 6D illustrates a new, secondary motion threshold and new selection regions. In this example, three new commands may be selected from the multidirectional button consisting of English words followed by a space character. The user may now move the press to the right, the positive X direction, at an angle appropriate to release the press in one of the three selection regions to choose one of the three secondary commands.

Illustrated in FIG. 6D, the third step of the example sequence is comprised of the user moving the press beyond the secondary motion threshold 68 to the final press position 65. This final press position is in selection region 63. The method, upon receiving a signal that the motion has exceeded the secondary motion threshold, changes the display of the secondary multidirectional button 66, as illustrated in FIG. 6C, to highlight the command in the lower right of the button. In this example, the selection region 64, illustrated in FIG. 6D issues the same command, upon press release, as will be issued if the release occurs when the selection position is within the secondary motion threshold.

In the fourth step of the example sequence, the user releases the press in selection region 63. This selection region corresponds to the English characters, and word, “and”, which is entered into the device.

In an aspect of the invention, a multidirectional button method may simply check, upon press release, that a press has not exceeded a motion threshold and the press has or has not moved in a direction. For example, in the previous example sequence, the button method may detect, upon press release, if the release position is in the negative X direction. If so, the press has not moved in the positive direction and the method would enter the command “a” into the device.

In the previous example sequence, the user pressed a button, moved the press in a direction, then moved the press in another direction, and released the press. This user input sequence resulted in a full word, and following space character, being entered into the device; whereby the reader can ascertain that typing can be accomplished little effort, high speed, and great accuracy with multidirectional buttons.

In an aspect of the invention, the exceeding of a secondary motion threshold and/or a press exceeding a time threshold when the press is in a secondary selection region, may initiate yet another level of commands. The terminology used to describe secondary menus in common software menus is the term “submenus”. Just as menus can lead to submenus, which can lead to more submenus, multidirectional buttons can lead to more and more multidirectional buttons. There is no theoretical limit to the number of command choices and multidirectional buttons, or we could say “sub-multidirectional-buttons”, which can come from an initial multidirectional button.

In a method of the invention, a method for implementing a software keyboard tracks the characters of a word that is currently being entered by the user. The method detects motion of one or more presses. The method, upon detection of motion exceeding a primary motion threshold initiates a secondary level of commands. The commands that will be executed upon the release of the press, if the motion of the press has exceeded a motion threshold, consist of keystrokes that complete possible words that are currently being typed. For example, if the user has currently begun a new word by typing the character “m”, before beginning the same user input sequence as in the previous example, the method will display a different set of secondary commands. FIG. 12 illustrates a secondary multidirectional button 120. In this example, three common English words are displayed in the secondary multidirectional button, as seen on the display screen 16. The three words displayed: “mad”, “made”, and “make” represent common English words that may be completed if the user chooses to move the press beyond a secondary motion threshold into one of their respective selection regions.

In a method of the invention, some methods implementing a software keyboard with multidirectional buttons: store characters entered by the user into the software keyboard; parse the stream of entered characters to determine the characters that have been entered of a word that is currently being entered into a device containing the software keyboard; look up possible words that the user may be entering in a software dictionary; and display secondary multidirectional buttons that contain one or more commands that consist of one or more words, optionally followed by the space character, that have been found in the software dictionary.

In an aspect of the invention, the software dictionary may contain words and a ranking of the frequency of use of the words in common language. A multidirectional button may contain a list of words in order of their frequency ranking found from the software dictionary.

In a method of the invention, a method for implementing a software keyboard: detects the crossing of a first motion threshold of a multidirectional button; displays a second level of command choices; detects the crossing of a secondary motion threshold; and displays a third level of command choices. The third level of commands may be comprised of, but not limited to, common variations of a word or combinations of words.

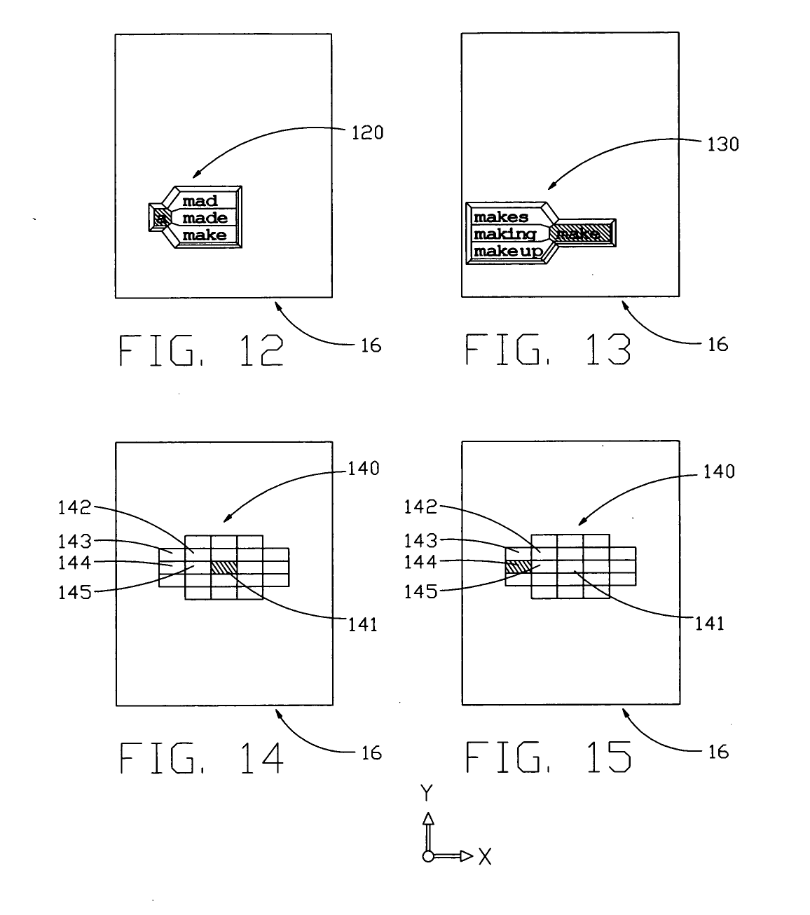

FIG. 12 illustrates a user sequence of commands, described previously, that initiates a second level multidirectional button. The button 120 contains three words “mad”, “made”, and “make” and the “a” character. If the user moves the press to the right and downward, into selection region 63, illustrated in FIG. 6D, the command “make” will become the new center selection. Upon the detection of the new center selection, the button method will display a third level of command choices. As illustrated in FIG. 13, the newly displayed multidirectional button 130 displays three new commands, comprised of the words “makes”, “making”, and “make up”. If the user were to subsequently move the press back to the left and down and release the press, the user could select the phrase “make up”, followed by the space key. In total, the user would have had to select the “m” key with a press, motion, and release, and then pressed a button, moved the press in three directions, and released the press to enter eight characters into the device. By comparison, on a conventional keyboard, the user would have had to move his fingers to eight keys and pressed and released the eight keys. As the reader can see, a software keyboard comprised of multilevel multidirectional buttons allows the user to enter complete words, and even pluralities of words, with a reduced amount of presses and motions. Further, the amount of motion required to exceed a motion threshold may be significantly less than the motion required to move between keys on a conventional keyboard.

In an aspect of the invention, a multilevel multidirectional button may wait to initiate a next level multidirectional button, or set of command choices, until the motion of a press has both exceeded a motion threshold and the motion is below a threshold of velocity and/or below a threshold of velocity for a threshold of time, and/or above a threshold of velocity or displacement in a direction substantially different from the direction of the press motion from the initial press point to the point at which the motion threshold was reached. There are many possible methods that a person skilled in the art could implement to determine when to initiate a next level multidirectional button. Further, a multilevel multidirectional button may initiate the next level while delaying displaying the button on the display screen. As such, a user who quickly moves a press in one or more directions need not be distracted by the display of multidirectional buttons flickering by on the screen.

In some embodiments of the invention, pluralities of multidirectional buttons comprise a keyboard, as has been disclosed previously. The key layout of a common keyboard may not be ideally adapted from common keys and buttons to multidirectional buttons. The most common keyboard layout in many countries is the QWERTY keyboard layout. FIG. 7 illustrates an example QWERTY keyboard layout 70 adapted to multidirectional buttons. All of the main Latin characters, A-Z, remain in substantially the same positions as they do on a common keyboard. This keyboard layout would provide a user, who is assumed to be familiar with the QWERTY layout, the easiest multidirectional button keyboard layout to learn. However, the center command, or key, choice in a multidirectional button is the most efficient command to execute. In the QWERTY layout, the characters “s”, “g”, and “k” occupy these positions. These characters, however, are not the most common characters to type.

In an embodiment of the invention, a keyboard consists of a plurality of multidirectional buttons. As illustrated in FIG. 8, the layout of the buttons is comprised of the QWERTY keyboard layout 80 with the positions of three key pairs swapped. The swapped pairs are the “s” character and the “e” character, the “g” character and the “t” character, the “k” character and the “i” character. The swapping of these three letter pairs will have the result that the center button command choices, or keys, are executed approximately 15% more often when typing common English text. (This has been found from commonly available character usage frequency data. The center commands are used approximately 22% of the time with the swapped pairs layout, verses 7% of the time with a conventional Qwerty layout during normal typing.) This keyboard layout will be herein referred to as the “Temple” keyboard layout.

The Temple keyboard layout will have a slightly higher learning curve, for a user accustomed to the QWERTY layout, but will result in greater typing efficiency. The Temple layout reduces the learning curve by only swapping adjacent keys. If the user looks for one of the six keys that have changed positions, the user will find the key, at most, one key away from the expected position. The reader should note that while the “a” key is the third most used character in the English language, the “a” key is not used as frequently as the “e” key. To place the “a” key in the center position of a multidirectional button would require that the “a” key be moved to a different multidirectional button, which would raise the learning curve substantially for a user accustomed to the QWERTY layout. (The Temple keyboard layout is only 1.3% less effective than if the “a” replaced the “i” key in a center position.)

In adapting the QWERTY keyboard layouts to multidirectional buttons, the “p” key, if left in its relative position to the other characters, sits alone in the right most of the four, nine commands per button, multidirectional buttons that comprise the basic Latin characters, as illustrated in FIG. 7 and FIG. 8. In an embodiment of the invention, the “p” is moved to be placed in the third, from the left, multidirectional button and to the right of the “m” key, as illustrated in FIG. 1A and FIG. 3A. In this embodiment, all of the basic Latin characters are contained in three multidirectional buttons. This minimizes the number of multidirectional buttons required to hold all of the basic Latin characters to three which can, in turn, allow for bigger sized multidirectional buttons for a given keyboard size.

Another common keyboard layout is the QWERTZ layout, widely used in Eastern European countries. The main difference between this layout and the common QWERTY layout is that the “Y” and “Z” characters are swapped. In an embodiment of the invention, the “Temple” layout, as well as the adapted QWERTY layouts of this disclosure, may be similarly adapted for countries that use the QWERTZ layout by swapping the “Y” and “Z” characters.

On a common QWERTY keyboard layout, the number keys are commonly above the basic character keys. These number keys do not adapt well to multidirectional buttons without changing their positions relative to a basic QWERTY keyboard layout. FIG. 7 illustrates the QWERTY keyboard layout, and the number keys, as adapted to multidirectional buttons. The reader can see that the number keys have been moved to the two upper right most multidirectional buttons. The multidirectional button containing the “1” through “9” keys has the number keys arranged in the same relative positions as found on the number pad of a common computer keyboard. The multidirectional button in the upper right contains the “0” key in the center, with an assortment of keys that are normally used with the number keys occupying the outer positions.

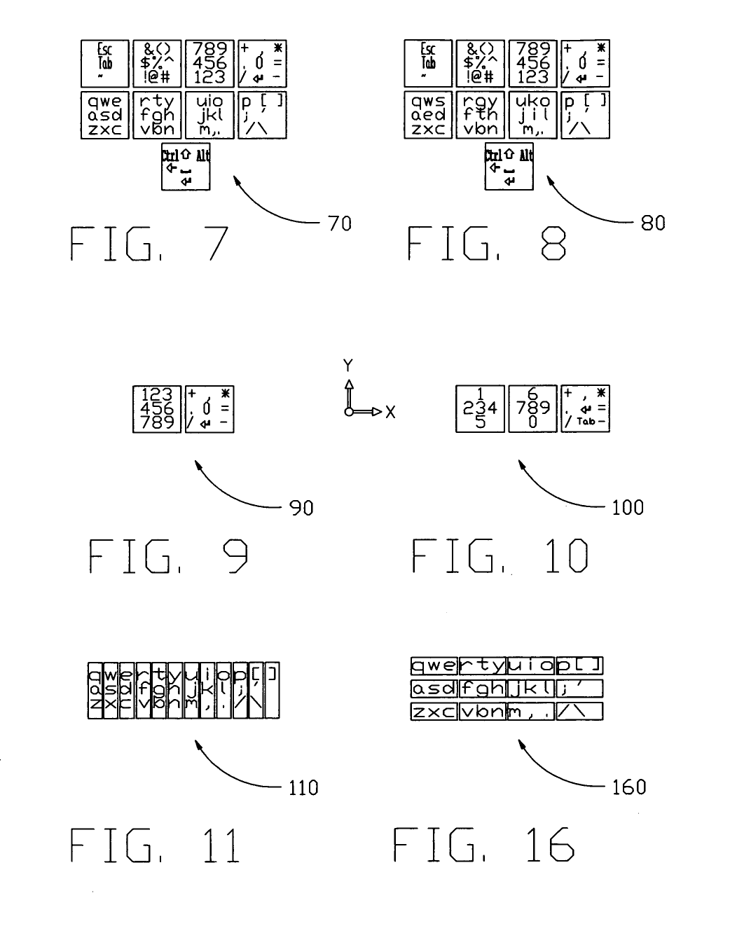

FIG. 9 illustrates a number pad 90 comprised of multidirectional buttons, which may be part of a larger keyboard layout, with the numbers “1” through “9” arranged in the position of a common phone key layout. The multidirectional button on the right contains the “0” key in the center, with an assortment of keys that are normally used with the number keys occupying the outer positions.

FIG. 10 illustrates another embodiment of a number pad 100 comprised of multidirectional buttons. In this embodiment, the numbers are placed in multidirectional buttons that are comprised of five command choices. Five command buttons are comprised of a center command choice and four command choices that may be selected by the user moving the press past a motion threshold into one of four selection regions. The buttons of this embodiment require less angular accuracy of the motion of the press from the user. This results in greater input accuracy, but at the expense of having another button which may result in the multidirectional buttons needing to be smaller to fit into a give space.

FIG. 11 illustrates an embodiment of the invention comprising the common QWERTY keyboard layout 110 implemented with three command multidirectional keys. Three command multidirectional keys have a center command selection that will be selected if the user releases a press of the button without press motion that has exceeded the motion threshold of the button. The center command is surrounded by two selection choices, one above the center command and one below the center command. The button method of this embodiment may simply detect press motion vertically, along the Y axis, to detect motion that has exceeded a motion threshold. As the reader can see in FIG. 11, if the user pressed the left most button, and released the press with no motion, the “a” character would be entered into the device. If the user pressed the same button and moved the press beyond the motion threshold in the positive Y direction and released the press, the “q” character would be entered into the device. The advantage to this keyboard layout is that the user needs less angular press motion accuracy. The disadvantage is that the buttons width would remain the same as a common keyboard layout. The user may prefer this keyboard layout if the user finds that flicking his fingers laterally, along the X axis, is not comfortable. Three command multidirectional buttons, as with all multidirectional buttons, may be embedded in common keyboards. For instance, the center rows of keys, (the “asd . . . ” row) in a common QWERTY keyboard, may be replaced by the keyboard layout 110 of FIG. 11.

FIG. 16 illustrates an embodiment of the invention comprising the common QWERTY keyboard layout 160 implemented with three command multidirectional keys. Three command multidirectional keys have a center command selection that will be selected if the user releases a press of the button without press motion that has exceeded the motion threshold of the button. The center command is surrounded by two selection choices, one to the left of the center command and one to the right of the center command. The button method of this embodiment may simply detect press motion horizontally, along the X axis, to detect motion that has exceeded a motion threshold. As the reader can see in FIG. 16, if the user pressed the top left most button, and released the press with no motion, the “w” character would be entered into the device. If the user pressed the same button and moved the press beyond the motion threshold in the negative X direction and released the press, the “q” character would be entered into the device. The advantage to this keyboard layout is that the user needs less angular press motion accuracy. The disadvantage is that the buttons height would remain the same as a common keyboard layout. However, the height of a key on a common keyboard is generally greater than its width, so this three-command multidirectional key keyboard layout may have greater accuracy than the prior embodiment illustrated in FIG. 11.

As the reader can surmise, adapting other commonly used keyboard layouts, such as the Dvorak keyboard layout or international keyboard layouts, to the keyboard layouts of this disclosure does not require special skills and is within the scope of the invention of placing a plurality of keystrokes and commands within multidirectional buttons.

Portable computing devices are often viewed in multiple orientations. The user of the devices may rotate a portable device to change screen orientation between portrait and landscape displays. Portable computing devices often contain an orientation sensor that provides signals for processes to change the orientation of the display screen. It is common for software keyboards to rotate with the display screen and for the software keyboards to adjust their size to fit when changing orientation. In a method of the invention, the method, upon detecting a signal to change screen orientation, changes the orientation of a software keyboard, of the invention, on the display screen. The software keyboard is comprised of a plurality of multidirectional buttons, and may contain non multidirectional buttons.

In an aspect of the invention, the software keyboard presented may change its layout, along with its size, in response to an orientation change.

In an embodiment of the invention, a portable computing device displays a conventional software keyboard in one orientation of the display screen, and the device displays a software keyboard, containing at least one multidirectional button, in the other orientation.

In an embodiment of the invention, a portable computing device displays a software keyboard, containing at least one multidirectional button with more than one copy of the multidirectional button on the display screen. For example, many users prefer to hold a portable device with two hands, and to type with their thumbs. If the device is sufficiently large that the user may not be able to comfortably use all the buttons of a keyboard, or other collection of user input objects, then a plurality of copies of buttons may be placed near the thumbs of the user. Whereby, the user may select a command from a button, which may be a multidirectional button, with either of his two thumbs.

In an aspect of the invention, the keyboards of this disclosure are compatible with many current software based typing enhancements. The enhancements comprise, but not limited to, one or more of the following: spelling correction, auto-correction, auto-capitalization, word prediction, and word disambiguating software.

Another enhancement is the modification of touch boundaries through predictive typing. In a method of the invention, the method: detects and stores the letters of a word that is currently being entered into the computing device; determines which commands are most likely to be entered next; and adjusts the size of the selection regions of multidirectional button selections; whereby the odds of the user selecting his intended user input command is increased. The size of a selection region may be changed by changing the motion threshold and/or by changing the angular aperture of the press motion.

In an aspect of the invention, multidirectional buttons of this disclosure may be embedded within other user interface objects such as, but not limited to, the keys of a common keyboard, number pad, menus, or other collection of buttons. Multidirectional buttons may be embedded within a keyboard that is primarily composed of common buttons, or keys.

In an aspect of the invention, a button method may respond to a press, a motion of the press exceeding a motion threshold, a press that exceeds a time threshold, a release of a press, and/or any button event by generating audible, tactile, and/or haptic user feedback. The type of user feedback may vary by button and by the type of event to which the feedback corresponds.

In a method of the invention, a multidirectional button method, upon detection of a press and motion exceeding a motion threshold, determines the angle of motion, with respect to the initial press position, and generates user feedback. The user feedback is different for motions that correspond to selection regions that are at approximately 90 degree angles to the positive X direction from selection regions that are at approximately 45 degree angles; whereby the user is given audible, tactile, and/or haptic feedback that informs the user of the direction of the press motion.

In a method of the invention, a multidirectional button method, upon detection of the selection of a command from the user, generates audible feedback, by any common means provided by computing devices, corresponding to the selected command. For example, feedback from a keyboard comprised of one or more multidirectional buttons may be comprised of an audible representation of the selected command, which can be a character. A blind user, for instance, could choose a character, such as the “a” character, and then get immediate feedback by hearing the letter “a” from the speaker of the device. A user interface comprised of multidirectional buttons of this disclosure, which may include a keyboard and other user interface objects, would be of great advantage to the visually impaired, if provided with this type of audible feedback. Further, multidirectional buttons can have much larger buttons, for the amount of commands that can be selected from them, compared to a group of conventional buttons. Thus, a visually impaired user would have less trouble pressing, and selecting from a multidirectional button.

### Additional Embodiments

In an embodiment of the invention, a computing device has a touch screen that additionally functions as a button. The touch screen can be pressed with a force, greater than the force needed for the detection of the press as a touch, sufficient to physically move the screen and generate a button press signal. In a computing device of this embodiment, a multidirectional button may track the motion of a touch allowing motion to occur and the button may detect the exceeding of a motion threshold without a preceding button press.

In an embodiment of the invention, a computing device has a physical multidirectional button, or key, that may be moved in a lateral direction, substantially perpendicular to the direction of a button press, beyond a motion threshold without the downward force, or movement, sufficient to be detected as a button press. In a computing device of this embodiment, a multidirectional button may detect the exceeding of a motion threshold without a preceding button press.

In an embodiment of the invention, a computing device contains one or more on-screen multidirectional button with which a user may interact with a mouse, or mouse substitute. The multidirectional button may be initiated by means other than a button press, such that in its initial state the mouse buttons are not pressed. In a computing device of this embodiment, a multidirectional button may track the motion of the mouse and detect the exceeding of a motion threshold without a preceding button press.

For the three proceeding embodiments, a multidirectional button may track motion without a preceding button press and distinguish between motion with and without a button press. In a method of the invention, a multidirectional button method, initialized by a process or event that may or may not be a button press, as in previous methods, comprises: detects one or more button presses and one or more motions beyond one or more motion thresholds; distinguishes between motion that exceeds a motion threshold with a preceding press and without a preceding press; detects one or more press releases; and determines one or more commands for the device from the sequence of button events.

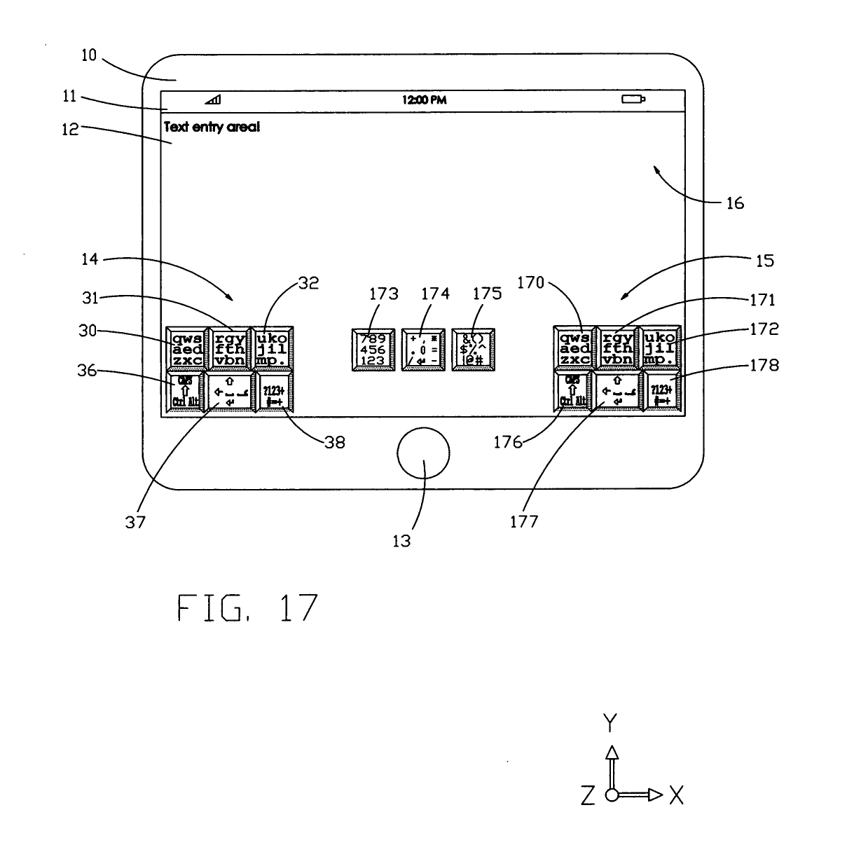

An example multidirectional button of the method is illustrated in FIG. 14 and FIG. 15. This example multidirectional button 140 is but one example of a multitude number of button patterns that could be made with a button of the method. FIG. 14 illustrates the button in its initial state. The center command selection, selection region 141, is highlighted. If the user presses and releases the button without motion of the press exceeding a motion threshold, the command associated with this selection will be entered into the device. If the user presses the button and moves the press to the left, the press will move to selection region 145. If the user releases the press in this selection region, the command associated with this selection will be entered into the device. However, if the user moves the button to the left without pressing the button, the button method will detect motion exceeding a motion threshold, without detecting a press, and selection region 144 is highlighted, as illustrated in FIG. 15. If a release of a press is detected, the command associated with this selection will be entered into the device. If the user presses the button and then moves the press in an upward direction, the press will be in selection region 143.

This example multidirectional button was chosen, from the many patterns that may be made with multidirectional buttons, to show that the multidirectional button may have different angular apertures defining selection regions for different motions. At the center of the multidirectional button of this example, eight selection regions surround the center default selection. To enter these selection regions, the user has to press the button and move the press past the motion threshold. Each of the eight selection regions surrounding the center region has selection regions that have an angular aperture of approximately 45 degrees. Selection region 142 is one of these regions. For the four outer selection regions, chosen by the user by motion of the button without a button press, the selection regions have angular apertures of approximately 90 degrees. Selection region 144 is one of these regions. For the eight outermost selection regions, chosen by the user by motion of the button without a button press followed by another motion, the selection regions have angular apertures of approximately 180 degrees. Selection region 143 is one of these regions.

The total number of selections that the user can reliably and quickly choose from in this example button, without needing to look at the button, is twenty one. Other patterns can be created with multidirectional buttons that have many more choices. As the reader can surmise, a multidirectional button of this method will allow for a large number of commands that the user could reliably choose from with high speed and great accuracy.

### SUMMARY, RAMIFICATIONS, AND SCOPE

The embodiments and aspects of the invention are disclosed herein to summarize the invention and are not intended to limit the scope of the invention.

The present disclosure generally relates to user input objects to enter commands into a computing device. The input objects are comprised of one or more multidirectional buttons and may contain other input objects. The disclosed embodiments and methods allow the user of the device to easily and quickly enter commands with high accuracy and speed, particularly with small portable computing devices with limited space.

The disclosed portable computing device reduces or eliminates the deficiencies and other problems associated with user input with computing devices, as listed above. In some embodiments, the device is portable. In some embodiments, the device has one or more display screens, the means to detect user input, one or more processors, memory and one or more modules, processes, programs, or sets of instructions stored in the memory for performing multiple functions. In some embodiments, the user presses one or more multidirectional buttons, moves the presses, and releases the presses to input commands into the device. Instructions for performing these functions may be included in a computer readable storage medium or other computer program product configured for execution by one or more processors. Instructions for performing these functions may apply one or more methods and heuristics to the motion to determine a command for the device, and instructions for processing the command.

The disclosed embodiments and methods allow computing devices with multidirectional buttons to behave in a manner desired by the user. Accordingly, the reader will see that a user interface with multidirectional buttons, which may also contain a keyboard comprised of multidirectional buttons, is a preferred method for inputting user commands.

The disclosure of the present invention, as well as references to the embodiments and methods, are not for limiting the scope of the invention. Persons having ordinary skill in the art may make various modifications and changes without departing from the scope and spirit of the invention. Therefore, the scope of the appended claims should not be limited to the description of the embodiments described above.

I claim:

1. A computer-implemented method of enabling a user to interact with an electronic device, the method implements a multidirectional button, key, or menu comprising: receiving one or more signals associated with one or more user presses; detecting some motion signals associated with some motions substantially perpendicular to the direction of the one or more presses; detecting some motions that may exceed one or more motion thresholds; detecting the directions of the motions; and applying an heuristic to the press signals and the motion signals and the detections of thresholds and the release signals to determine a command for the device, wherein a command is executed by the device.

2. The method of claim 1, wherein the presses comprise the user pressing one or more fingers on the touch screen of the device, the releases comprise the user removing one or more fingers off of the touch screen, the motions comprise the user sliding one or more fingers across the touch screen. The motion thresholds comprise the user sliding on or more fingers beyond a threshold displacement.

3. The method of claim 1, wherein the presses comprise the user pressing one or more mouse buttons of the device, the releases comprise the user releasing the one or more mouse buttons, the motions comprise the user moving the mouse, and the motion thresholds comprise the user moving the mouse beyond a threshold of displacement.

4. The method of claim 1, wherein the presses comprise the user pressing one or more physical multidirectional buttons of the device, the releases comprise the user releasing said multidirectional buttons, the motions comprise the user moving said multidirectional button, and the motion thresholds comprise the user moving said multidirectional button beyond a threshold displacement.

5. The method of claim 1, wherein the directions of the motions are determined from coordinates, communicated to the method from one or more motion signals, by calculating one or more angles from an axis that lies in the plane of the top surface of said multidirectional buttons.

6. The method of claim 1, wherein the detection of one or more motions exceeding one or more motion thresholds is comprised of comparing coordinates, communicated to the method from one or more motion signals, of one or more initial press signals to one or more current positions of motion signals.

7. The method of claim 1, wherein the method of claim 1 determines the command for the device from a selection region in which a release occurs.

8. The method of claim 7, wherein the selection region is comprise of an area bounded by a motion threshold and an angular aperture and one of the following: some extents of the motion or a second motion threshold.

9. The method of claim 1, wherein the method, initiated by an initial button press, changes the button display and processing of one or more buttons. The method, upon detection of a second press, a motion of the second press, if any, and the release of the second press prior to the release of the press that initiated the method, enters a command into the device. Upon release of the initiating press, the command that would be entered into the device, if the second press had not been detected, will be suppressed.

10. The method of claim 1, further including: starting a system timer when the press of a multidirectional button is detected or a button press has exceeded a motion threshold, wherein the system timer sends a timer signal to the button method at a set interval, or rate of time; detecting some timer signals; entering a keystroke or command into the device in response to receiving the timer signal prior to the detection of the release of the pressed key; turning off the system timer upon detection of the release of the press. Whereby, the user may enter a plurality of commands into the device.

11. The method of claim 1, further including: detecting some press, motion, and/or release signals, and generating audible, tactile, and/or haptic user feedback in response to the detecting of the signals.

12. The method of claim 11, further including: providing different user feedback for motions that correspond to selection regions that are at approximately 90 degree angles to the positive X direction, from selection regions that are at approximately 45 degree angles; whereby the user is given audible, tactile, and/or haptic feedback that informs the user of the direction of the press motion.

13. The method of claim 11, further including: providing audible user feedback corresponding to the command selected from a multidirectional; whereby the user is given audible feedback of the command that has been selected.

14. The method of claim 1, further including: means to implement a keyboard, comprising a plurality of buttons, with a least one button being a multidirectional button of claim 1, whereby user may interact with an electronic device by typing.

15. The method of claim 14, further including: detecting a plurality of user presses of a plurality of buttons, with a least one button being a multidirectional button. The method, upon detecting some user releases of the presses, enters a “space” key command to the device.

16. The method of claim 14, further including: detecting a plurality of user presses, within a time threshold, of a plurality of buttons, with a least one button being a multidirectional button. The method, upon detecting some user releases of the presses, enters a “space” key command to the device.

17. The method of claim 14, further including: detecting the user pressing the keyboard with two fingers and then moving the two presses towards, or away from each other; and means for resizing, splitting, or joining elements of the keyboard comprised of buttons, keys, or other elements.

18. The method of claim 14, further including: detecting the user pressing the software keyboard with two fingers and then moving the two presses in substantially the same direction, beyond motion thresholds; and means for moving the keyboard on the display screen. Whereby, the user may move the keyboard to suit his typing style.

19. The method of claim 14, further including: detecting the user pressing the software keyboard with two fingers and then moving the two presses in opposite, and generally rotational, directions, beyond motion thresholds; and means for changing the orientation of the keyboard.

20. The method of claim 14, further including: tracking the characters of a word that are currently being entered by the user; and detecting motion of one or more presses. The method, upon detection of motion exceeding a primary motion threshold initiates a secondary level of commands. The commands that will be executed upon the release of the press, if the motion of the press has exceeded a motion threshold, consist of keystrokes that complete possible words that are currently being typed.

21. The method of claim 14, further including: storing characters entered by the user into the software keyboard; parsing the stream of entered characters to determine the characters that have been entered of a word that is currently being entered into the device; looking up possible words that the user may be entering in a software dictionary; and displaying secondary multidirectional buttons that contain one or more commands that consist of one or more words, optionally followed by the space character, that have been found in the software dictionary.

22. The method of claim 14, the method, initiated by an initial button press, changes the button display and processing of one or more buttons to display alphabetical characters of the opposite case. The method, upon detection of a second press and a motion of the second press, if any, prior to the release of the press that initiated the method, enters one or more characters into the device. Upon release of the initiating press, the command that would be entered into the device, if the second press had not been detected, will be suppressed.

23. The method of claim 14, the method: detects the crossing of a first motion threshold of a multidirectional button; displays a second level of command choices; detects the crossing of a secondary motion threshold; and displays a third level of command choices. The third level of commands may be comprised of, but not limited to, common variations of a word or combinations of words.

24. The method of claim 14, the method: detects and stores the letters of a word that is currently being entered into the computing device; determines which commands are most likely to entered next; and adjusts the size of the selection regions of multidirectional button selections; whereby the odds of the user selecting his intended user input command is increased. The size of a selection region may be changed by changing the motion thresholds and/or by changing the angular apertures of the press motion.

25. The method of claim 14, the method further including: detecting changes in device orientation, and means for a traditional software keyboard in one orientation of the display screen, and displaying a software keyboard, containing at least one multidirectional button of claim 1, in the other orientation.

26. The method of claim 14, wherein the keyboard comprising at least three multidirectional buttons of claim 1, three of the buttons contain at least twenty six alphabetic characters, such that at least two of the multidirectional buttons contain nine characters displayed in a grid of three characters by three characters,
with the first row of the first key containing the letters, left to right, Q, W, S,
with the second row of the first key containing the letters, left to right, A, E, D,
with the third row of the first key containing the letters, middle to right, X, C,
with the first row of the second key containing the letters, left to middle, R, G,
with the second row of the second key containing the letters, left to right, F, T, H,
with the third row of the second key containing the letters, left to right, V, B, N,
with the first row of the third key containing the letters, left to right, U, K, O,
with the second row of the third key containing the letters, left to right, J, I, L,
with the third row of the third key containing the letter M on the left,
wherein the first button is to the left side of the second button, and the second button is to the left side of the third button.

27. The method of claim 14, wherein the keyboard comprising at least three multidirectional buttons of claim 1, three of the buttons contain at least twenty six alphabetic characters, such that at least two of the multidirectional buttons contain nine characters displayed in a grid of three characters by three characters,
with the first row of the first key containing the letters, left to right, Q W, E,
with the second row of the first key containing the letters, left to right, A, S, D,
with the third row of the first key containing the letters, middle to right, X, C,
with the first row of the second key containing the letters, left to middle, R, T,
with the second row of the second key containing the letters, left to right, F, G, H,
with the third row of the second key containing the letters, left to right, V, B, N,
with the first row of the third key containing the letters, left to right, U, I, O,
with the second row of the third key containing the letters, left to right, J, K, L,
with the third row of the third key containing the letter M on the left,
wherein the first button is to the left side of the second button and the second button is to the left side of the third button.

28. The method of claim 14, wherein the keyboard comprising a plurality of substantially similar buttons disposed on opposing sides of the keyboard; whereby, the user may use either of his hands to make a command choice.

29. The method of claim 1, further including: detecting motion of an initiating press beyond a motion threshold, and/or a press exceeding a time threshold; changing other buttons or objects, which may or may not be multidirectional buttons.

30. The method of claim 29 wherein the changing other buttons or objects are comprised of the replacement of a screen object with another object, which may be a multidirectional button, the changing of commands issued by a multidirectional button, and/or the changing of multidirectional button boundaries, motion thresholds, and/or time thresholds, and/or the display of a multidirectional button, or other screen objects on the display screen.

31. A computing device, comprising: one or more display screens; one or more processors; memory; and one or more programs, wherein the one or more programs are stored in the memory and configured to be executed by the one or more processors, the one or more programs including: instructions for displaying and processing one or more virtual multidirectional buttons on one or more display screens; and instructions for detecting user presses, motions, and releases, and for determining the exceeding of motion thresholds and instructions of determining one or more commands for the device.

32. In a method of the invention, a multidirectional button method, initialized by a process or event that may or may not be a button press, comprises: detecting some button events, wherein the button events comprise: one or more button presses; some motions beyond some motion thresholds; some press releases; the method further comprising: distinguishing motion that exceeds a motion threshold with a preceding press from motion without a preceding press; detecting and determining one or more commands for the device from the sequence of button events.
